(19) United States
(12) Patent Application Publication
(10) Pub. No.: US 2025/0111592 A1
(43) Pub. Date: Apr. 3, 2025

(54) SINGLE IMAGE TO REALISTIC 3D OBJECT GENERATION VIA SEMI-SUPERVISED 2D AND 3D JOINT TRAINING

(71) Applicant: NVIDIA Corporation, Santa Clara, CA (US)

(72) Inventors: Dejia Xu, San Jose, CA (US); Morteza Mardani, Santa Clara, CA (US); Jiaming Song, San Carlos, CA (US); Sifei Liu, Santa Clara, CA (US); Ye Yuan, Santa Clara, CA (US); Arash Vahdat, San Mateo, CA (US)

(21) Appl. No.: 18/892,186

(22) Filed: Sep. 20, 2024

Related U.S. Application Data
(60) Provisional application No. 63/542,257, filed on Oct. 3, 2023.

(51) Int. Cl. G06T 15/20; G06V 10/774; G06V 10/776; G06V 10/82

(52) U.S. Cl. CPC G06T 15/20; G06V 10/774; G06V 10/776; G06V 10/82

(57) ABSTRACT

Virtual reality and augmented reality bring increasing demand for 3D content creation. In an effort to automate the generation of 3D content, artificial intelligence-based processes have been developed. However, these processes are limited in terms of the quality of their output because they typically involve a model trained on limited 3D data thereby resulting in a model that does not generalize well to unseen objects, or a model trained on 2D data thereby resulting in a model that suffers from poor geometry due to ignorance of 3D information. The present disclosure jointly uses both 2D and 3D data to train a machine learning model to be able to generate 3D content from a single 2D image.

### CLAIM OF PRIORITY

This application claims the benefit of U.S. Provisional Application No. 63/542,257 (Attorney Docket No. NVIDP1386+/23-SC-0689US01) titled “SINGLE IMAGE TO REALISTIC 3D OBJECT GENERATION VIA SEMI-SUPERVISED 2D AND 3D JOINT TRAINING,” filed Oct. 3, 2023, the entire contents of which is incorporated herein by reference.

### TECHNICAL FIELD

The present disclosure relates to artificial intelligence-based processes for generating three-dimensional (3D) content.

### BACKGROUND

Virtual reality and augmented reality bring increasing demand for 3D content. However, creating high-quality 3D content has conventionally required tedious work that a human expert must do. In an effort to automate this work, artificial intelligence-based processes have been developed to generate 3D content. However, these processes are limited in terms of the quality of their output.

For example, one existing solution utilizes multi-view supervision to construct learnable 3D priors. This approach generally learns a model that can generate 3D information based on an input two-dimensional (2D) image. However, due to the limited amount of 3D data (i.e. multi-view images) available for training, this approach suffers from poor generalization and exhibits limited performance when the test image is out-of-distribution from the original training dataset.

Another existing solution aims to construct 3D content based on 2D priors only. In one example, knowledge from a pre-trained 2D text-to-image diffusion model is distilled into a Neural Radiance Field (NeRF) and then text-to-3D synthesis can be performed. When integrated with additional regularizations to reconstruct the input image, the pipeline is naturally extended to generate 3D objects that look like the input 2D image. However, this solution requires per-instance optimization of the model and suffers from poor geometry due to its ignorance of 3D information.

There is a need for addressing these issues and/or other issues associated with the prior art. For example, there is a need to jointly train a machine learning model on both 2D and 3D data to be able to generate 3D content from a single 2D image.

### SUMMARY

A method, computer readable medium, and system are disclosed for 2D and 3D joint training of a machine learning model to generate 3D content from a 2D image. A 2D dataset comprised of single-view images labeled with texture information is accessed. A 3D dataset comprised of multi-view images labeled with geometry information is accessed. The 2D dataset and the 3D dataset are jointly used to train a machine learning model to generate a 3D content given an input 2D image.

### BRIEF DESCRIPTION OF THE DRAWINGS

FIG. 1 illustrates a method for training a machine learning model to generate a 3D content for a given input image, in accordance with an embodiment, in accordance with an embodiment.

FIG. 2 illustrates a method for joint 2D and 3D training of a machine learning model to generate a 3D content for a given input image, in accordance with an embodiment.

FIG. 3A illustrates a training pipeline on a 3D dataset for the machine learning model described with respect to FIG. 2, in accordance with an embodiment.

FIG. 3B illustrates a training pipeline on a 2D dataset for the machine learning model described with respect to FIG. 2, in accordance with an embodiment.

FIG. 4 illustrates a method for deploying the machine learning model described with respect to FIG. 1, in accordance with an embodiment.

FIG. 5 illustrates a method in which the machine learning model described with respect to FIG. 1 is used by a downstream application, in accordance with an embodiment.

FIG. 6A illustrates inference and/or training logic, according to at least one embodiment;

FIG. 6B illustrates inference and/or training logic, according to at least one embodiment;

FIG. 7 illustrates training and deployment of a neural network, according to at least one embodiment;

FIG. 8 illustrates an example data center system, according to at least one embodiment.

### DETAILED DESCRIPTION

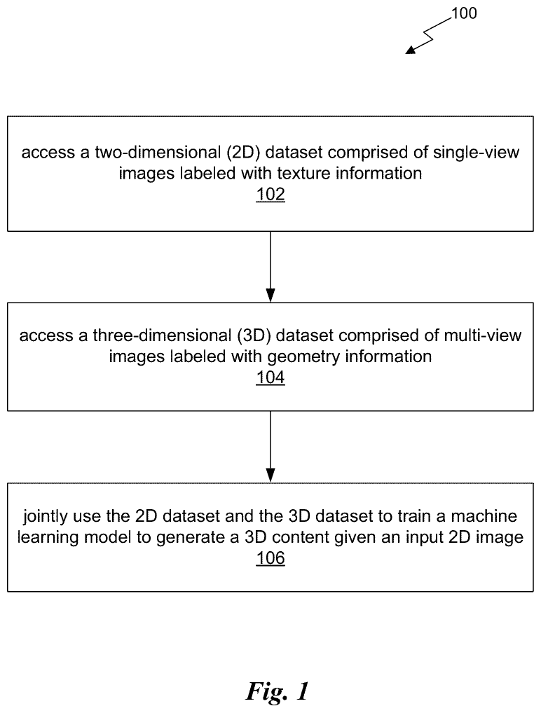

FIG. 1 illustrates a method 100 for training a machine learning model to generate a 3D content for a given input image, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, a 2D dataset comprised of single-view images labeled with texture information is accessed. The 2D dataset refers to a collection of single-view images labeled with texture information. In the present embodiment, the single-view images are 2D images. The 2D images may be in-the-wild images or synthesized images. “Single-view” refers to the 2D dataset having singular images of various scenes, objects, etc. The singular images may be generated from various (e.g. camera) viewpoints, in an embodiment.

As mentioned, the single-view images are labeled with texture information. The texture information may include an indication of one or more textures in the image. For example, the texture of one or more objects in the image may be labeled. Of course, the single-view images may also be labeled with other information, such as viewpoint, depth, object classifications, camera pose, etc. In an embodiment, the single-view images in the 2D dataset may not be labeled with geometry information.

The 2D dataset may be accessed from a repository. The repository may be locally or remotely stored with respect to the computer system performing the method 100. In an embodiment, the 2D dataset may be publicly available online.

In operation 104, a 3D dataset comprised of multi-view images labeled with geometry information is accessed. The 3D dataset refers to a collection of multi-view images labeled with geometry information. In the present embodiment, the multi-view images are 2D images of static objects. “Multi-view” refers to the 3D dataset having groups of images, with each group capturing a different (e.g. camera) viewpoint of a same scene, object, etc. Thus, in an embodiment, a group of images may be in-the-wild images of a same scene, object, etc. taken from different viewpoints. In another embodiment, a group of images may be synthetic images, possibly generated from a 3D content, which capture different viewpoints of a same scene, object, etc.

As mentioned, the multi-view images are labeled with geometry information. The geometry information may include an indication of one or more geometrical shapes in the image. For example, the geometrical 3D shape of one or more objects in the image may be labeled. Of course, the multi-view images may also be labeled with other information, such as viewpoint, depth, object classifications, camera parameters, etc. In an embodiment, the multi-view images in the 3D dataset may not be labeled with texture information.

The 3D dataset may be accessed from a repository. The repository may be locally or remotely stored with respect to the computer system performing the method 100. In an embodiment, the 3D dataset may be publicly available online.

In operation 106, the 2D dataset and the 3D dataset are jointly used to train a machine learning model to generate a 3D content given an input 2D image. With respect to the present embodiment, the 3D content is a 3D representation of a scene, object, etc. depicted in the input 2D image. The 3D representation may be a triplane, volume grid, feature point cloud, or implicit representation, for example. The 3D content may be structured such that 2D views of the 3D content may be capable of being generated.

In an embodiment, the given input 2D image may be a single 2D image. In other words, the machine learning model may be trained such that the 3D content can be generated from only a single input 2D image. The input 2D image may be an in-the-wild image or a synthetic image.

The machine learning model that is trained using both the 2D dataset and the 3D dataset refers to any type of machine learning model that is trainable to generate 3D content given an input 2D image. In an embodiment, the machine learning model may be a generative machine learning model. In an embodiment, the machine learning model may include one or more components that are trainable using the 2D dataset and the 3D dataset. For example, the machine learning model may include a trainable encoder, as described in more detail below.

With respect to the present embodiment, jointly using the 2D dataset and the 3D dataset to train the machine learning model refers to training the same machine learning model on both the 2D dataset and the 3D dataset. In an embodiment, the training may be semi-supervised. By jointly using the 2D dataset and the 3D dataset to train the machine learning model, the model may be trained on both the textures from the 2D dataset and the geometries of the 3D dataset. This may improve the texture and geometry of any 3D content generated by the model. In an embodiment, jointly using the 2D dataset and the 3D dataset to train the machine learning model may include first training the machine learning model using the 3D dataset and second training the machine learning using the 2D dataset.

As mentioned above, an encoder may be shared during the training of the machine learning model using the 2D dataset and the 3D dataset. In an embodiment, during the training of the machine learning model using the 3D dataset the encoder may generate a 3D representation of an input image from the 3D dataset. In an embodiment, during the training of the machine learning model using the 2D dataset the encoder may generate a 3D representation of an input image from the 2D dataset.

In a further embodiment, a renderer of the model may be shared during the training of the machine learning model using the 2D dataset and the 3D dataset. In an embodiment, during the training of the machine learning model using the 3D dataset the renderer may convert the 3D representation of the input image from the 3D dataset into a first set of 2D renderings using viewpoints from the 3D dataset. In an embodiment, during the training of the machine learning model using the 2D dataset the renderer may convert the 3D representation of the input image from the 2D dataset into a second set of 2D renderings that includes a reconstructed view of the input image from the 2D dataset and a novel view of the input image from the 2D dataset.

Still yet, during the training of the machine learning model using the 3D dataset, a first loss may be computed between the first set of 2D renderings and a ground truth from the 3D dataset. In an embodiment, during the training of the machine learning model using the 3D dataset, the first set of 2D renderings may be supervised using the first loss. For example, the first loss may compare one or more features between the first set of 2D renderings and a ground truth from the 3D dataset. Such features may include texture, silhouette, geometry information, depth, surface normal, etc.

Furthermore, during the training of the machine learning model using the 2D dataset, a second loss may be computed between the reconstructed view of the input image from the 2D dataset and the input image from the 2D dataset. In an embodiment, during the training of the machine learning model using the 2D dataset, the reconstructed view of the input image from the 2D dataset may be supervised using the second loss. In an embodiment, the second loss may compare one or more features between the reconstructed view of the input image from the 2D dataset and the input image from the 2D dataset. These features may include texture, geometry information, etc.

Also during the training of the machine learning model using the 2D dataset, a third loss may be computed between the novel view of the input image from the 2D dataset and the input image from the 2D dataset. In an embodiment, the novel view of the input image from the 2D dataset may be supervised using the third loss. In an embodiment, the third loss may compare one or more features between the novel view of the input image from the 2D dataset and the input image from the 2D dataset. These features may include texture, geometry information, etc.

In an embodiment, during the training of the machine learning model using the 2D dataset, the encoder may be used to generate a 3D representation of the novel view of the input image from the 2D dataset. In an embodiment, cycle consistency may be enforced by minimizing a difference between the 3D representation of the novel view of the input image from the 2D dataset and the 3D representation of the input image from the 2D dataset. In another embodiment, during the training of the machine learning model using the 2D dataset, at least one discriminator may be used to ensure that the novel view of the input image from the 2D dataset is realistic compared to the input image from the 2D dataset. In still yet another embodiment, a geometry prior may be further used to unsupervisedly train the machine learning model to learn geometry.

In an optional embodiment, the method 100 may further include deploying the trained machine learning model. In an embodiment, the trained machine learning model may be deployed for use by at least one downstream application. Just by way of example, the at least one downstream application may include a virtual reality application or an augmented reality application. The downstream application may be a gaming application, video conferencing application, navigational application, etc. In an embodiment, the method 100 may further include processing a single input 2D image, by the deployed machine learning model, to generate 3D content, and then outputting the 3D content. For example, the 3D content may be output for rendering one or more 2D images therefrom with respect to one or more different viewpoints.

In one possible alternative implementation of the method 100, the single-view images in the 2D dataset may not necessarily be labeled with texture information and the multi-view images in the 3D dataset may not necessarily be labeled with geometry information. In this exemplary implementation, the method 100 may include accessing a 2D dataset comprised of labeled single-view images, accessing a 3D dataset comprised of labeled multi-view images, and jointly using the 2D dataset and the 3D dataset to train a machine learning model to generate a 3D content given an input 2D image. In an embodiment, the single-view images may be labeled with texture information or any other type of information. In an embodiment, the multi-view images may be labeled with geometry information or any other type of information. The remaining description of the method 100, as illustrated in FIG. 1, may equally apply to the present alternative implementation.

Further embodiments will now be provided in the description of the subsequent figures. It should be noted that the embodiments disclosed herein with reference to the method 100 of FIG. 1 may apply to and/or be used in combination with any of the embodiments of the remaining figures below.

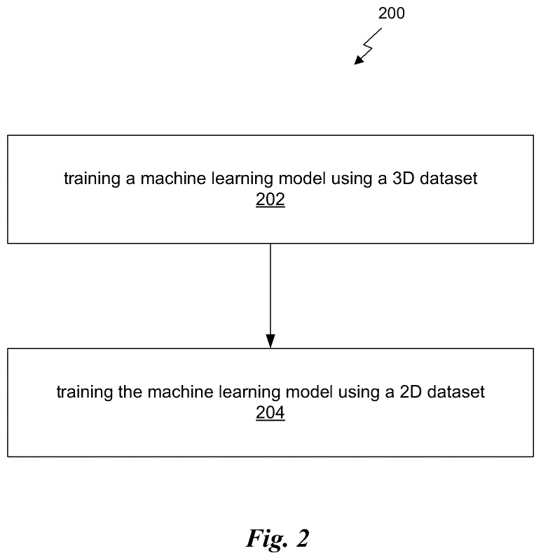

FIG. 2 illustrates a method 200 for joint 2D and 3D training of a machine learning model to generate a 3D content for a given input image, in accordance with an embodiment. The method 200 may be carried out in the context of the method 100 of FIG. 1, in an embodiment. For example, the method 200 may be carried out to perform operation 106 of FIG. 1. Of course, however, the method 200 may be carried out in any desired context. It should be noted that the descriptions and definitions provided above may equally apply to the present description.

In operation 202, a machine learning model is trained using a 3D dataset. In an embodiment, the 3D dataset is comprised of multi-view images labeled at least with geometry information. In an embodiment, the machine learning model is trained using the 3D dataset by training the machine learning model to reconstruct samples in the 3D dataset. The training of the machine learning model using the 3D dataset may be an initial (first) training step for the machine learning model.

In operation 204, the machine learning model is trained using a 2D dataset. In an embodiment, the 2D dataset is comprised of single-view images labeled at least with texture information. In an embodiment, the machine learning model is trained using the 2D dataset by training the machine learning model to reconstruct samples in the 2D dataset and to generate novel views from samples in the 2D dataset. The training of the machine learning model using the 2D dataset may be a subsequent (second) training step for the machine learning model.

To this end, in accordance with the present method 200, the machine learning model may be initially trained on the 3D dataset and then subsequently trained on the 2D dataset. With respect to the present method 200, the machine learning model is trained to generate a 3D content given an input image. Training on the 3D dataset initially may result in the model learning to generate different views of an object/scene in the given input image, in an embodiment primarily focusing on the geometry of such object/scene. Subsequently training on the 2D dataset may result in the model learning to generate details for novel views of the object/scene in the given input image, in an embodiment primarily focusing on the textures of such object/scene. In this way the training of the machine learning model may be considered to be semi-supervised.

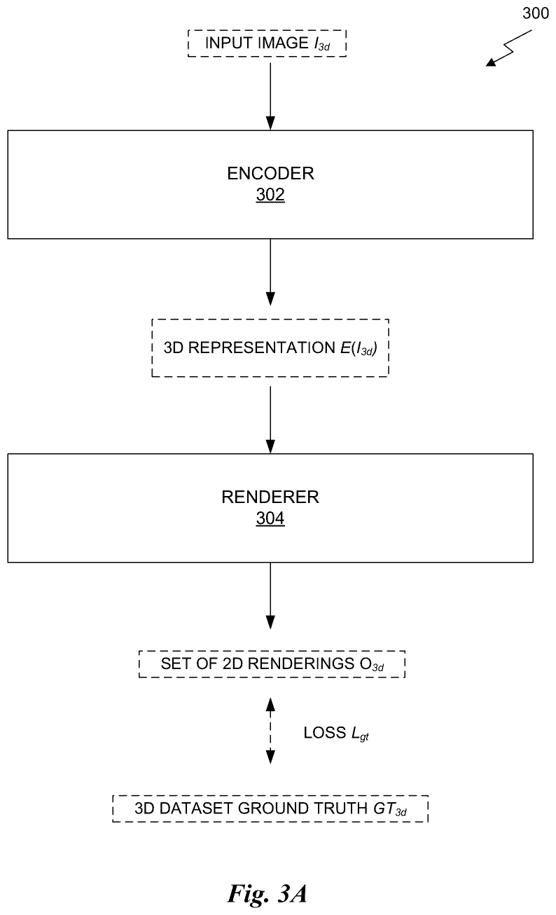

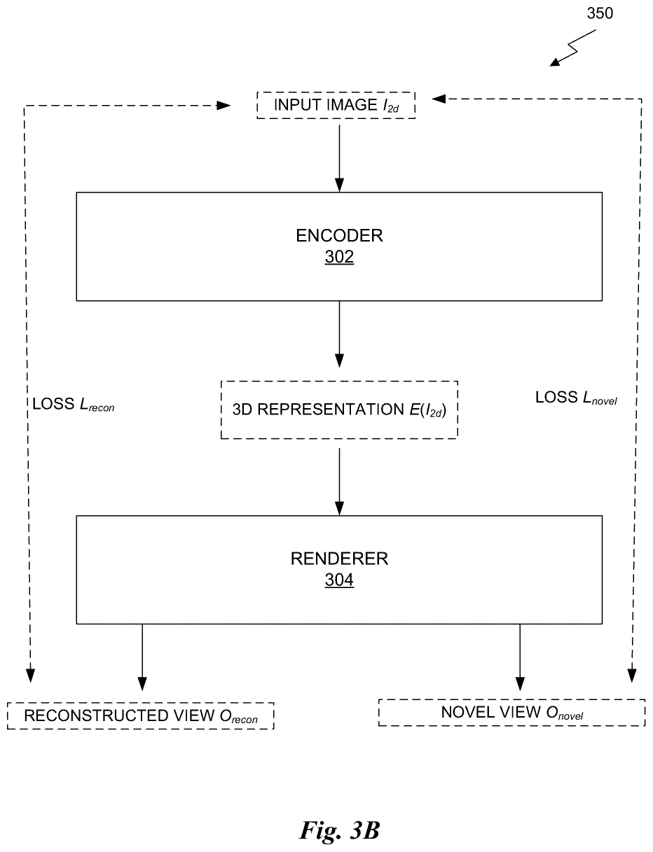

FIG. 3A illustrates a training pipeline 300 on a 3D dataset for the machine learning model described with respect to FIG. 2, in accordance with an embodiment. The training pipeline 300 may be implemented for carrying out operation 202 of FIG. 2. FIG. 3B illustrates a training pipeline 350 on a 2D dataset for the machine learning model described with respect to FIG. 2, in accordance with an embodiment. The training pipeline 350 may be implemented for carrying out operation 204 of FIG. 2.

The training pipeline 300 relies on a 3D dataset that contains multi-view images capable of providing well-annotated supervision for geometry. The training pipeline 350 relies on a 2D dataset that contains single-view images with realistic textures capable of enabling detail-preserving texture learning through reconstruction. Since 3D datasets usually have poor textures and 2D datasets have no geometry information, the 2D and 3D datasets are considered unlabeled training sets. In an embodiment, pseudo labels are provided through score distillation loss and geometry priors.

Returning to the training pipeline 300 show in FIG. 3A, given an input image I_{3d} from the 3D dataset, the pipeline 300 first uses an encoder E(·) to encode it into a 3D representation E(I_{3d}). Then, a differentiable renderer R(·) is used to convert the 3D representation E(I_{3d}) into 2D renderings O_{3d} using the cameras from the 3D dataset. An L_{gt} loss is used to compare the 2D renderings O_{3d} with the corresponding ground truth GT_{3d} from the 3D dataset. Thus, for 3D data, the training pipeline 300 supervises the 2D renderings using the loss L_{gt}. The loss not only compares the rendered RGB image that represents texture and silhouette but also may compare the geometry information, including depth and surface normal.

With respect to the training pipeline 350 show in FIG. 3B, given an in-the-wild real image I₂ₐ from the 2D dataset, the encoder E(·) is used to encode it into a 3D representation E(I_{2d}). Then, the differentiable renderer R(·) is used to convert the 3D representation E(I_{2d}) into 2D renderings O_{recon} and Oₙₒᵥₑₗ using a pre-defined camera distribution. More specifically, the input view I_{2d} is reconstructed and reconstruction loss L_{recon} between I_{2d} and O_{recon} is calculated. Additionally, cameras are randomly sampled from novel viewpoints and a novel view similarity loss Lₙₒᵥₑₗ between 12a and Oₙₒᵥₑₗ is calculated. Thus, for 2D data, the reconstructed view is supervised using reconstruction loss L_{recon}. The loss ensures that the input view is well reconstructed in terms of texture and geometry. For novel views Oₙₒᵥₑₗ, a similarity loss (e.g. CLIP similarity loss), score distillation loss, and variational score distillation loss are used to supervise the texture and geometry.

In an embodiment, geometry priors (e.g. smoothness, distortion loss, relative information from monocular depth) may also be used to improve the geometry unsupervisedly. In an embodiment, cycle consistency may be enforced by sending the Oₙₒᵥₑₗ into the encoder E(·) to generate a 3D representation E(Oₙₒᵥₑₗ) and then minimizing the difference between E(I_{2d}) and E(Oₙₒᵥₑₗ). In another embodiment, discriminators may be utilized to ensure the novel view renderings Oₙₒᵥₑₗ (both texture and geometry) are realistic compared to the ground truth data.

In embodiments, a UNet model or vision transformer model may be used as the encoder E(·). In embodiments, a variational autoencoder (VAE) structure or vector quantized techniques may be used to improve the encoder's performance. In embodiments, the 3D representation may be a triplane, volume grid, feature point cloud, or implicit representation. In embodiments, the renderer R(·) may employ volumetric rendering methods and surface-based rendering methods, and may be a NeRF-like volumetric renderer or a deep marching tetrahedra (DMTet) renderer. For rendering texture, a volume grid, a texture triplane, implicit representation, or feature point cloud may be used. In embodiments, the 3D representation may be placed canonically in the world space as in the ground truth placement in the 3D dataset, or may be aligned with the input view in the camera space, or may be placed horizontally aligned with axis by inferring the elevation of the input view.

To this end, both 2D and 3D information may be used to learn the machine learning model, which may be a 3D generative model that can generate 3D objects given a single input image. With the help of rich 2D information, the generalization issue of existing 3D generative models is alleviated. Further, compared with existing works that utilize 2D score distillation loss to construct 3D objects, the present model benefits from the multi-view supervision and is able to learn better geometry. Moreover, the training pipelines 300, 350 do not require per-instance fine-tuning and the model can reconstruct 3D shapes in significantly less time.

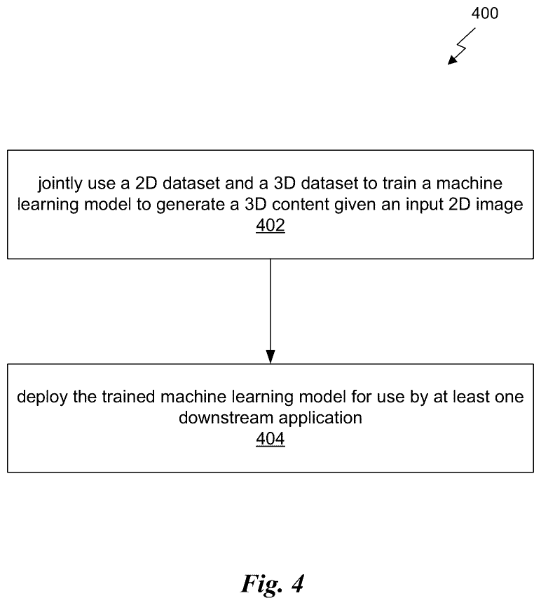

FIG. 4 illustrates a method 400 for deploying the machine learning model described with respect to FIG. 1, in accordance with an embodiment. In operation 402, a 2D dataset and a 3D dataset are jointly used to train a machine learning model to generate a 3D content given an input 2D image. This training may be performed in accordance with any of the previous embodiments described above.

In operation 404, the trained machine learning model is deployed for use by at least one downstream application. In an embodiment, the at least one downstream application may be a virtual reality application. In an embodiment, the at least one downstream application may be an augmented reality application.

In an embodiment, the trained machine learning model may be deployed to a cloud server for use by multiple different downstream applications. In an embodiment, the trained machine learning model may be deployed to a local computing system executing a particular downstream application.

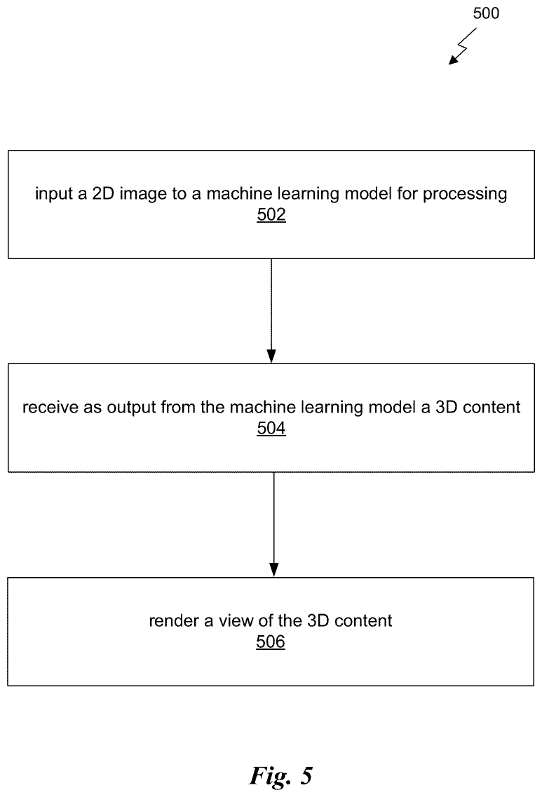

FIG. 5 illustrates a method 500 in which the machine learning model described with respect to FIG. 1 is used by a downstream application, in accordance with an embodiment. The method 500 may be performed with respect to the machine learning model deployed in accordance with the method 400 of FIG. 4.

In operation 502, a 2D image is input to a machine learning model for processing. As mentioned, the machine learning model refers to the one described with respect to FIG. 1 that has been trained on 2D and 3D images to generate 3D content for a given input 2D image. The 2D image is input to the machine learning model by the downstream application.

In operation 504, a 3D content is received as output from the machine learning model. In particular, the machine learning model processes the 2D image to generate the 3D content which is returned to the downstream application.

In operation 506, a view of the 3D content is generated. In particular, the downstream application generates a 2D image from a select viewpoint of the 3D content. This view maybe based on a context within the downstream application (e.g. a user perspective in a video game, etc.). The downstream application may generate any number of different 2D images from any number of different viewpoints of the 3D content.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

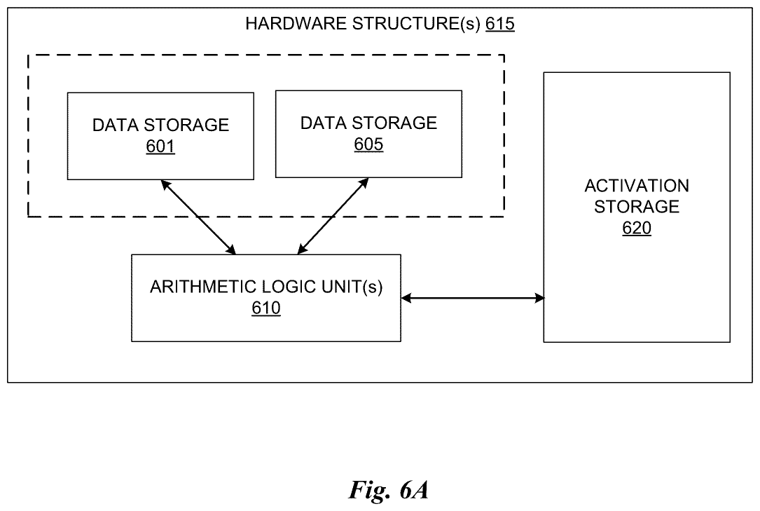

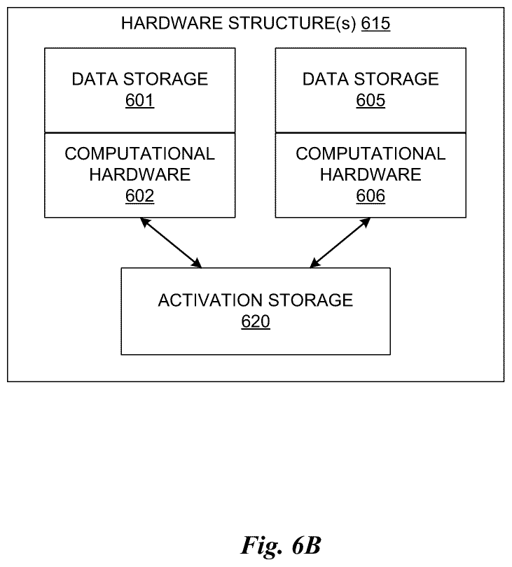

As noted above, a deep learning or neural learning system needs to be trained to generate inferences from input data. Details regarding inference and/or training logic 615 for a deep learning or neural learning system are provided below in conjunction with FIGS. 6A and/or 6B.

In at least one embodiment, inference and/or training logic 615 may include, without limitation, a data storage 601 to store forward and/or output weight and/or input/output data corresponding to neurons or layers of a neural network trained and/or used for inferencing in aspects of one or more embodiments. In at least one embodiment data storage 601 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 601 may be included with other on-chip or off-chip data storage, including a processor's L1, L2, or L3 cache or system memory.

In at least one embodiment, any portion of data storage 601 may be internal or external to one or more processors or other hardware logic devices or circuits. In at least one embodiment, data storage 601 may be cache memory, dynamic randomly addressable memory (“DRAM”), static randomly addressable memory (“SRAM”), non-volatile memory (e.g., Flash memory), or other storage. In at least one embodiment, choice of whether data storage 601 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 615 may include, without limitation, a data storage 605 to store backward and/or output weight and/or input/output data corresponding to neurons or layers of a neural network trained and/or used for inferencing in aspects of one or more embodiments. In at least one embodiment, data storage 605 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 605 may be included with other on-chip or off-chip data storage, including a processor's L1, L2, or L3 cache or system memory. In at least one embodiment, any portion of data storage 605 may be internal or external to on one or more processors or other hardware logic devices or circuits. In at least one embodiment, data storage 605 may be cache memory, DRAM, SRAM, non-volatile memory (e.g., Flash memory), or other storage. In at least one embodiment, choice of whether data storage 605 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 601 and data storage 605 may be separate storage structures. In at least one embodiment, data storage 601 and data storage 605 may be same storage structure. In at least one embodiment, data storage 601 and data storage 605 may be partially same storage structure and partially separate storage structures. In at least one embodiment, any portion of data storage 601 and data storage 605 may be included with other on-chip or off-chip data storage, including a processor's L1, L2, or L3 cache or system memory.

In at least one embodiment, inference and/or training logic 615 may include, without limitation, one or more arithmetic logic unit(s) (“ALU(s)”) 610 to perform logical and/or mathematical operations based, at least in part on, or indicated by, training and/or inference code, result of which may result in activations (e.g., output values from layers or neurons within a neural network) stored in an activation storage 620 that are functions of input/output and/or weight parameter data stored in data storage 601 and/or data storage 605. In at least one embodiment, activations stored in activation storage 620 are generated according to linear algebraic and or matrix-based mathematics performed by ALU(s) 610 in response to performing instructions or other code, wherein weight values stored in data storage 605 and/or data 601 are used as operands along with other values, such as bias values, gradient information, momentum values, or other parameters or hyperparameters, any or all of which may be stored in data storage 605 or data storage 601 or another storage on or off-chip. In at least one embodiment, ALU(s) 610 are included within one or more processors or other hardware logic devices or circuits, whereas in another embodiment, ALU(s) 610 may be external to a processor or other hardware logic device or circuit that uses them (e.g., a co-processor). In at least one embodiment, ALUs 610 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 601, data storage 605, and activation storage 620 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 620 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 620 may be cache memory, DRAM, SRAM, non-volatile memory (e.g., Flash memory), or other storage. In at least one embodiment, activation storage 620 may be completely or partially within or external to one or more processors or other logical circuits. In at least one embodiment, choice of whether activation storage 620 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 615 illustrated in FIG. 6A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6A may be used in conjunction with central processing unit (“CPU”) hardware, graphics processing unit (“GPU”) hardware or other hardware, such as field programmable gate arrays (“FPGAs”).

FIG. 6B illustrates inference and/or training logic 615, according to at least one embodiment. In at least one embodiment, inference and/or training logic 615 may include, without limitation, hardware logic in which computational resources are dedicated or otherwise exclusively used in conjunction with weight values or other information corresponding to one or more layers of neurons within a neural network. In at least one embodiment, inference and/or training logic 615 illustrated in FIG. 6B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6B may be used in conjunction with central processing unit (CPU) hardware, graphics processing unit (GPU) hardware or other hardware, such as field programmable gate arrays (FPGAs). In at least one embodiment, inference and/or training logic 615 includes, without limitation, data storage 601 and data storage 605, which may be used to store weight values and/or other information, including bias values, gradient information, momentum values, and/or other parameter or hyperparameter information. In at least one embodiment illustrated in FIG. 6B, each of data storage 601 and data storage 605 is associated with a dedicated computational resource, such as computational hardware 602 and computational hardware 606, respectively. In at least one embodiment, each of computational hardware 606 comprises one or more ALUs that perform mathematical functions, such as linear algebraic functions, only on information stored in data storage 601 and data storage 605, respectively, result of which is stored in activation storage 620.

In at least one embodiment, each of data storage 601 and 605 and corresponding computational hardware 602 and 606, respectively, correspond to different layers of a neural network, such that resulting activation from one “storage/computational pair 601/602” of data storage 601 and computational hardware 602 is provided as an input to next “storage/computational pair 605/606” of data storage 605 and computational hardware 606, in order to mirror conceptual organization of a neural network. In at least one embodiment, each of storage/computational pairs 601/602 and 605/606 may correspond to more than one neural network layer. In at least one embodiment, additional storage/computation pairs (not shown) subsequent to or in parallel with storage computation pairs 601/602 and 605/606 may be included in inference and/or training logic 615.

### Neural Network Training and Deployment

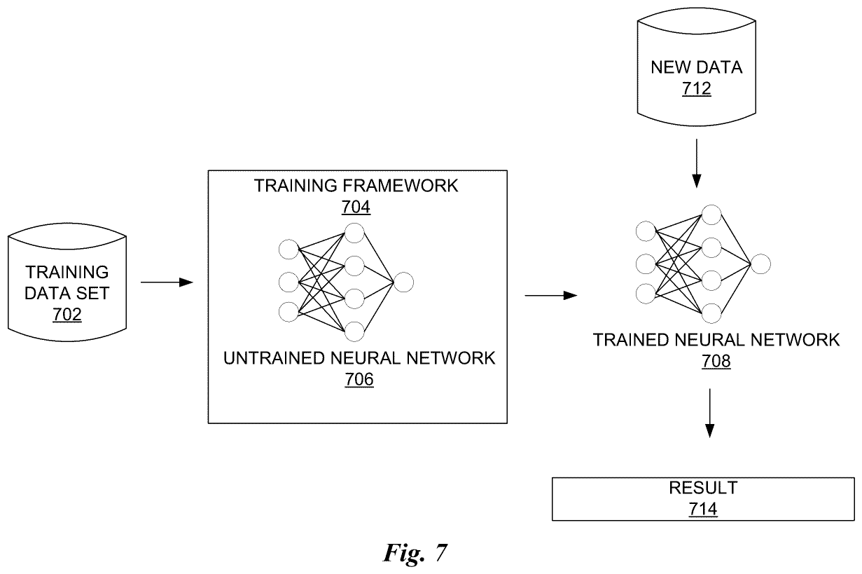

FIG. 7 illustrates another embodiment for training and deployment of a deep neural network. In at least one embodiment, untrained neural network 706 is trained using a training dataset 702. In at least one embodiment, training framework 704 is a PyTorch framework, whereas in other embodiments, training framework 704 is a Tensorflow, Boost, Caffe, Microsoft Cognitive Toolkit/CNTK, MXNet, Chainer, Keras, Deeplearning4j, or other training framework. In at least one embodiment training framework 704 trains an untrained neural network 706 and enables it to be trained using processing resources described herein to generate a trained neural network 708. In at least one embodiment, weights may be chosen randomly or by pre-training using a deep belief network. In at least one embodiment, training may be performed in either a supervised, partially supervised, or unsupervised manner.

In at least one embodiment, untrained neural network 706 is trained using supervised learning, wherein training dataset 702 includes an input paired with a desired output for an input, or where training dataset 702 includes input having known output and the output of the neural network is manually graded. In at least one embodiment, untrained neural network 706 is trained in a supervised manner processes inputs from training dataset 702 and compares resulting outputs against a set of expected or desired outputs. In at least one embodiment, errors are then propagated back through untrained neural network 706. In at least one embodiment, training framework 704 adjusts weights that control untrained neural network 706. In at least one embodiment, training framework 704 includes tools to monitor how well untrained neural network 706 is converging towards a model, such as trained neural network 708, suitable to generating correct answers, such as in result 714, based on known input data, such as new data 712. In at least one embodiment, training framework 704 trains untrained neural network 706 repeatedly while adjust weights to refine an output of untrained neural network 706 using a loss function and adjustment algorithm, such as stochastic gradient descent. In at least one embodiment, training framework 704 trains untrained neural network 706 until untrained neural network 706 achieves a desired accuracy. In at least one embodiment, trained neural network 708 can then be deployed to implement any number of machine learning operations.

In at least one embodiment, untrained neural network 706 is trained using unsupervised learning, wherein untrained neural network 706 attempts to train itself using unlabeled data. In at least one embodiment, unsupervised learning training dataset 702 will include input data without any associated output data or “ground truth” data. In at least one embodiment, untrained neural network 706 can learn groupings within training dataset 702 and can determine how individual inputs are related to untrained dataset 702. In at least one embodiment, unsupervised training can be used to generate a self-organizing map, which is a type of trained neural network 708 capable of performing operations useful in reducing dimensionality of new data 712. In at least one embodiment, unsupervised training can also be used to perform anomaly detection, which allows identification of data points in a new dataset 712 that deviate from normal patterns of new dataset 712.

In at least one embodiment, semi-supervised learning may be used, which is a technique in which in training dataset 702 includes a mix of labeled and unlabeled data. In at least one embodiment, training framework 704 may be used to perform incremental learning, such as through transferred learning techniques. In at least one embodiment, incremental learning enables trained neural network 708 to adapt to new data 712 without forgetting knowledge instilled within network during initial training.

### Data Center

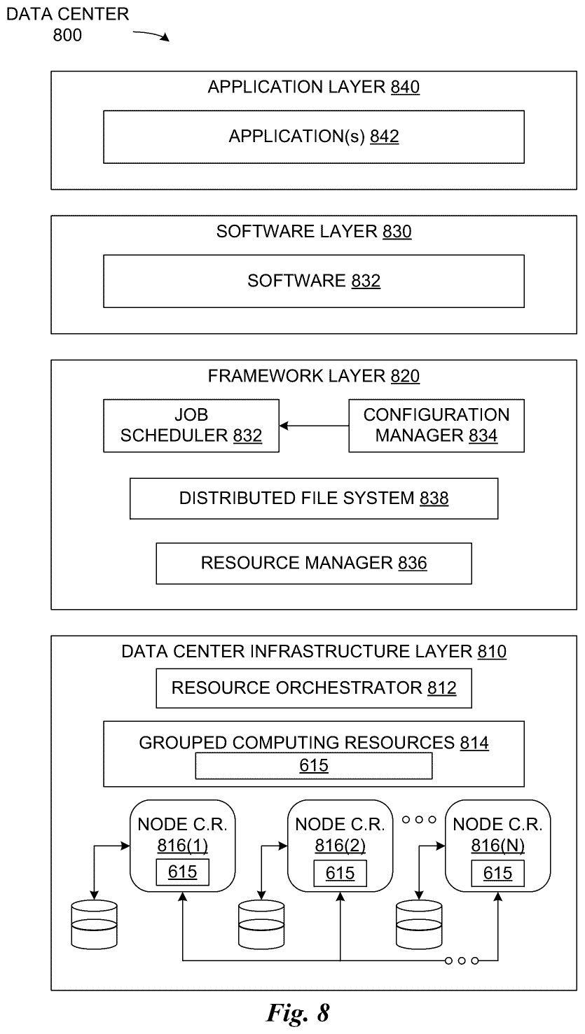

FIG. 8 illustrates an example data center 800, in which at least one embodiment may be used. In at least one embodiment, data center 800 includes a data center infrastructure layer 810, a framework layer 820, a software layer 830 and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 822 may configure or otherwise control one or more node C.R.s 816(1)-816(N) and/or grouped computing resources 814. In at least one embodiment, resource orchestrator 822 may include a software design infrastructure (“SDI”) management entity for data center 800. In at least one embodiment, resource orchestrator may include hardware, software or some combination thereof.

In at least one embodiment, as shown in FIG. 8, framework layer 820 includes a job scheduler 832, a configuration manager 834, a resource manager 836 and a distributed file system 838. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 832 may include a Spark driver to facilitate scheduling of workloads supported by various layers of data center 800. In at least one embodiment, configuration manager 834 may be capable of configuring different layers such as software layer 830 and framework layer 820 including Spark and distributed file system 838 for supporting large-scale data processing. In at least one embodiment, resource manager 836 may be capable of managing clustered or grouped computing resources mapped to or allocated for support of distributed file system 838 and job scheduler 832. In at least one embodiment, clustered or grouped computing resources may include grouped computing resource 814 at data center infrastructure layer 810. In at least one embodiment, resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 8 for inferencing or predicting operations based, at least in part, on weight parameters calculated using neural network training operations, neural network functions and/or architectures, or neural network use cases described herein.

As described herein with reference to FIGS. 1-5, a method, computer readable medium, and system are disclosed for 3D content creation, which relies on a trained machine learning model. The model may be stored (partially or wholly) in one or both of data storage 601 and 605 in inference and/or training logic 615 as depicted in FIGS. 6A and 6B. Training and deployment of the model may be performed as depicted in FIG. 7 and described herein. Distribution of the model may be performed using one or more servers in a data center 800 as depicted in FIG. 8 and described herein.

What is claimed is:

1. A method, comprising:
at a device:
accessing a two-dimensional (2D) dataset comprised of single-view images labeled with texture information;
accessing a three-dimensional (3D) dataset comprised of multi-view images labeled with geometry information; and
jointly using the 2D dataset and the 3D dataset to train a machine learning model to generate a 3D content given an input 2D image.

2. The method of claim 1, wherein the single-view images in the 2D dataset are not labeled with geometry information.

3. The method of claim 1, wherein the multi-view images in the 3D dataset are not labeled with texture information.

4. The method of claim 1, wherein the training is semi-supervised.

5. The method of claim 1, wherein jointly using the 2D dataset and the 3D dataset to train the machine learning model includes:
first training the machine learning model using the 3D dataset, and
second training the machine learning using the 2D dataset.

6. The method of claim 1, wherein an encoder is shared during the training of the machine learning model using the 2D dataset and the 3D dataset.

7. The method of claim 6, wherein:
during the training of the machine learning model using the 3D dataset the encoder generates a 3D representation of an input image from the 3D dataset, and
during the training of the machine learning model using the 2D dataset the encoder generates a 3D representation of an input image from the 2D dataset.

8. The method of claim 7, wherein a renderer is shared during the training of the machine learning model using the 2D dataset and the 3D dataset.

9. The method of claim 8, wherein:
during the training of the machine learning model using the 3D dataset the renderer converts the 3D representation of the input image from the 3D dataset into a first set of 2D renderings using viewpoints from the 3D dataset, and
during the training of the machine learning model using the 2D dataset the renderer converts the 3D representation of the input image from the 2D dataset into a second set of 2D renderings that includes a reconstructed view of the input image from the 2D dataset and a novel view of the input image from the 2D dataset.

10. The method of claim 9, wherein during the training of the machine learning model using the 3D dataset, a first loss is computed between the first set of 2D renderings and a ground truth from the 3D dataset.

11. The method of claim 10, wherein during the training of the machine learning model using the 3D dataset, the first set of 2D renderings are supervised using the first loss.

12. The method of claim 11, wherein the first loss compares one or more features between the first set of 2D renderings and a ground truth from the 3D dataset.

13. The method of claim 12, wherein the one or more features include texture.

14. The method of claim 12, wherein the one or more features include silhouette.

15. The method of claim 12, wherein the one or more features include geometry information.

16. The method of claim 15, wherein the geometry information includes depth.

17. The method of claim 15, wherein the geometry information includes surface normal.

18. The method of claim 9, wherein during the training of the machine learning model using the 2D dataset:
a second loss is computed between the reconstructed view of the input image from the 2D dataset and the input image from the 2D dataset, and
a third loss is computed between the novel view of the input image from the 2D dataset and the input image from the 2D dataset.

19. The method of claim 18, wherein during the training of the machine learning model using the 2D dataset:
the reconstructed view of the input image from the 2D dataset is supervised using the second loss, and
the novel view of the input image from the 2D dataset is supervised using the third loss.

20. The method of claim 19, wherein the second loss compares one or more features between the reconstructed view of the input image from the 2D dataset and the input image from the 2D dataset.

21. The method of claim 20, wherein the one or more features include texture.

22. The method of claim 20, wherein the one or more features include geometry information.

23. The method of claim 19, wherein the third loss compares one or more features between the novel view of the input image from the 2D dataset and the input image from the 2D dataset.

24. The method of claim 23, wherein the one or more features include texture.

25. The method of claim 23, wherein the one or more features include geometry information.

26. The method of claim 9, wherein during the training of the machine learning model using the 2D dataset:
using the encoder to generate a 3D representation of the novel view of the input image from the 2D dataset, and
enforcing cycle consistency by minimizing a difference between the 3D representation of the novel view of the input image from the 2D dataset and the 3D representation of the input image from the 2D dataset.

27. The method of claim 9, wherein during the training of the machine learning model using the 2D dataset, using at least one discriminator to ensure that the novel view of the input image from the 2D dataset is realistic compared to the input image from the 2D dataset.

28. The method of claim 1, further comprising, at the device:
using a geometry prior to unsupervisedly train the machine learning model to learn geometry.

29. The method of claim 1, further comprising, at the device:
deploying the trained machine learning model.

30. The method of claim 29, wherein the trained machine learning model is deployed for use by at least one downstream application.

31. The method of claim 30, wherein the at least one downstream application includes a virtual reality application.

32. The method of claim 30, wherein the at least one downstream application includes an augmented reality application.

33. The method of claim 29, further comprising, at the device:
processing a single input 2D image, by the deployed machine learning model, to generate 3D content; and
outputting the 3D content.

34. A system, comprising:
a non-transitory memory storage comprising instructions; and
one or more processors in communication with the memory, wherein the one or more processors execute the instructions to:
access a two-dimensional (2D) dataset comprised of single-view images labeled with texture information;
access a three-dimensional (3D) dataset comprised of multi-view images labeled with geometry information; and
jointly use the 2D dataset and the 3D dataset to train a machine learning model to generate a 3D content given an input 2D image.

35. The system of claim 34, wherein jointly using the 2D dataset and the 3D dataset to train the machine learning model includes:
first training the machine learning model using the 3D dataset, and
second training the machine learning using the 2D dataset.

36. The system of claim 34, wherein an encoder is shared during the training of the machine learning model using the 2D dataset and the 3D dataset.

37. The system of claim 36, wherein:
during the training of the machine learning model using the 3D dataset the encoder generates a 3D representation of an input image from the 3D dataset, and
during the training of the machine learning model using the 2D dataset the encoder generates a 3D representation of an input image from the 2D dataset.

38. The system of claim 37, wherein a renderer is shared during the training of the machine learning model using the 2D dataset and the 3D dataset.

39. The system of claim 38, wherein:
during the training of the machine learning model using the 3D dataset the renderer converts the 3D representation of the input image from the 3D dataset into a first set of 2D renderings using viewpoints from the 3D dataset, and
during the training of the machine learning model using the 2D dataset the renderer converts the 3D representation of the input image from the 2D dataset into a second set of 2D renderings that includes a reconstructed view of the input image from the 2D dataset and a novel view of the input image from the 2D dataset.

40. The system of claim 39, wherein during the training of the machine learning model using the 3D dataset, the first set of 2D renderings are supervised using a first loss computed between the first set of 2D renderings and a ground truth from the 3D dataset.

41. The system of claim 39, wherein during the training of the machine learning model using the 2D dataset:
the reconstructed view of the input image from the 2D dataset is supervised using a second loss computed between the reconstructed view of the input image from the 2D dataset and the input image from the 2D dataset, and
the novel view of the input image from the 2D dataset is supervised using a third loss computed between the novel view of the input image from the 2D dataset and the input image from the 2D dataset.

42. A non-transitory computer-readable media storing computer instructions which when executed by one or more processors of a device cause the device to:
access a two-dimensional (2D) dataset comprised of single-view images labeled with texture information;
access a three-dimensional (3D) dataset comprised of multi-view images labeled with geometry information; and
jointly use the 2D dataset and the 3D dataset to train a machine learning model to generate a 3D content given an input 2D image.

43. The non-transitory computer-readable media of claim 42, wherein the device is further caused to:
deploy the trained machine learning model, wherein the trained machine learning model is deployed for use by at least one downstream application.

44. The non-transitory computer-readable media of claim 43, wherein the at least one downstream application includes a virtual reality application.

45. The non-transitory computer-readable media of claim 43, wherein the at least one downstream application includes an augmented reality application.

46. The non-transitory computer-readable media of claim 43, wherein the device is further caused to:
process a single input 2D image, by the deployed machine learning model, to generate 3D content; and
output the 3D content.

47. A method, comprising:
at a device:
accessing a two-dimensional (2D) dataset comprised of labeled single-view images;
accessing a three-dimensional (3D) dataset comprised of labeled multi-view images; and
jointly using the 2D dataset and the 3D dataset to train a machine learning model to generate a 3D content given an input 2D image.

48. The method of claim 1, wherein the single-view images are labeled with texture information.

49. The method of claim 1, wherein the multi-view images are labeled with geometry information.
